(19) United States
(12) Patent Application Publication
(10) Pub. No.: US 2005/0087619 A1
(43) Pub. Date: Apr. 28, 2005

(54) One-way straw

(76) Inventor: Fadi Hector Nasr, Canyon Lake, CA (US)

Correspondence Address: FADI HECTOR NASR, 30420 WHITE COVE CT, CANYON LAKE, CA, 92587, US

(21) Appl. No.: 10/692,455

(22) Filed: Oct. 24, 2003

(51) Int. Cl. A61J 15/00

(52) U.S. Cl. 239/33

(57) ABSTRACT

A straw for drinking fluids that has conical rings or any extensions attached on the outside of it to make it go into a hole of a vessel with ease, but make it difficult to remove. The straw enables young children to drink from the drinking vessel without being able to remove the straw. The straw will remain attached to the vessel under most circumstances.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The field of the invention is applicable in all vessels containing a dispensable fluid that requires the use of a straw to extract it out; these vessels have a hole in which a straw is inserted (from now on these vessels are referred to as VCDF). The problem with existing straws is that they can be removed from the VCDF so easily, allowing a child to lose them, causing the VCDF to spill and make a mess. The invention provides a new straw that can be inserted in the hole of the VCDF with ease, but is very difficult to remove. The invention assures that the straw will remain attached to VCDF. This new straw is used just like the familiar straw, for drinking, while at the same time it prevents loss of the straw and helps decrease messes due to spillage of the fluid. By having the straw always attached to the vessel, a child will not have to lose it, nor try to re-insert it (a difficult job for a child) since it does not come out.

### BRIEF SUMMARY OF THE INVENTION

A straw for drinking fluids that has conical rings or any extensions attached on the outside of it to make it go into a hole of a vessel with ease, but make it difficult to remove. The straw is an open tube which allows the fluid to flow through it. On the outer side of the straw conical rings or any extensions are attached to make the insertion of the straw into the hole of a vessel easy, but make removing it difficult. Removing the straw will be difficult since the conical rings or extensions will oppose the motion of removal.

### BRIEF DESCRIPTION OF THE SEVERAL VIEWS OF THE DRAWING

FIG. 1 shows a three dimensional view of the invention, with one of the many possible ways to have the outside extensions.

FIG. 2 shows a three dimensional view of the invention, with one of the many possible ways to have the outside extensions.

FIG. 3 shows a cross-sectional view of the invention (sliced longitudinally), with one of the many possible ways to have the outside extensions.

### DETAILED DESCRIPTION OF THE INVENTION

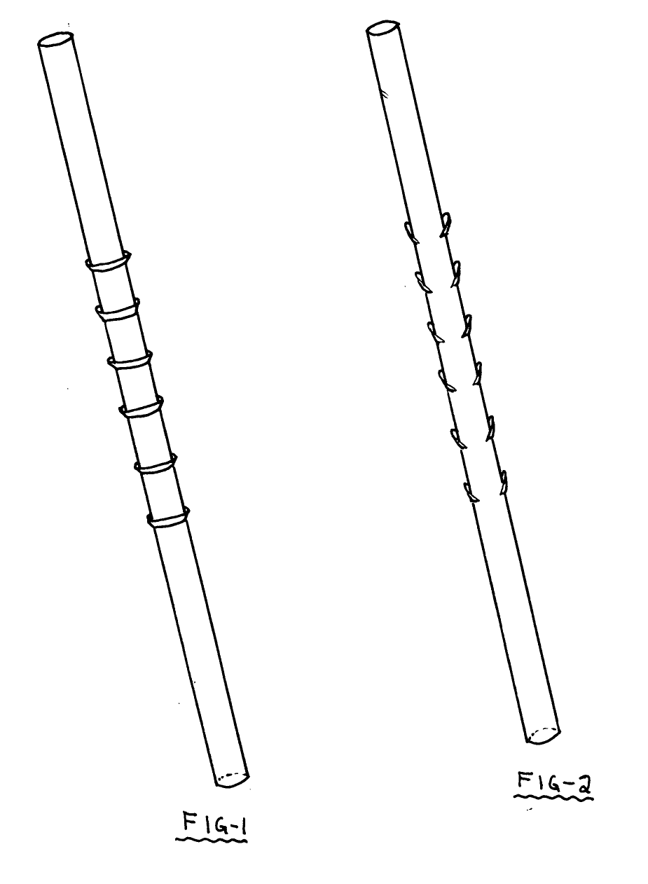

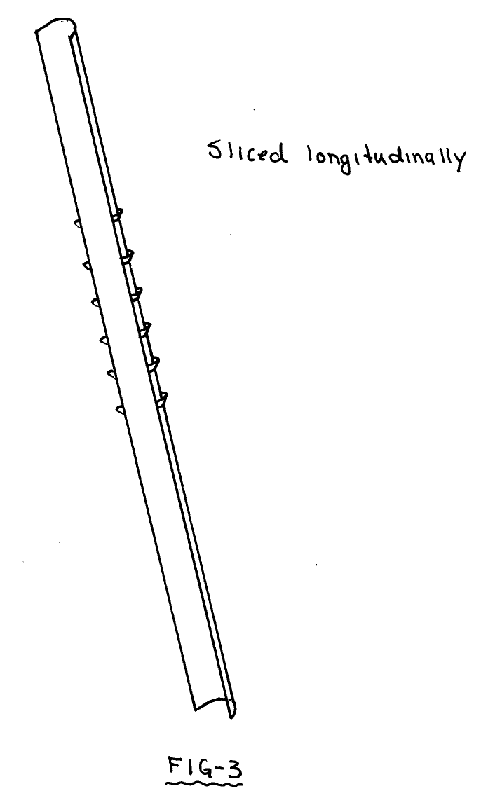

The invention is a straw for drinking fluids that has conical rings or any extensions attached on the outside of it to make it go into a hole of a vessel with ease, but make it difficult to remove FIG. 1 and FIG. 2. The straw is an open tube which allows the fluid to flow through it FIG. 3. On the outer side of the straw conical rings or any extensions are attached to make the insertion of the straw into the hole of a vessel easy. Inserting is easy since the conical shapes or any extensions fold inwards as the straw is inserted. Removing the straw will be difficult since the conical rings or extensions will oppose the motion of removal.

1. What I claim as my invention is a straw for drinking fluids that has conical rings or any extensions attached on the outside of it.
